(19) United States
(12) Patent Application Publication
(10) Pub. No.: US 2017/0091681 A1
(43) Pub. Date: Mar. 30, 2017

(54) SYSTEM AND METHOD FOR PROVIDING A DYNAMIC LOADBOARD

(71) Applicant: Valerio Lanzieri, Ile Bizard (CA)

(72) Inventor: Valerio Lanzieri, Ile Bizard (CA)

(21) Appl. No.: 15/276,752

(22) Filed: Sep. 26, 2016

Related U.S. Application Data
(60) Provisional application No. 62/233,229, filed on Sep. 25, 2015.

(51) Int. Cl. G06Q 10/06; G06Q 50/28

(52) U.S. Cl. CPC G06Q 10/06311; G06Q 50/28

(57) ABSTRACT

The invention relates to a method for matching orders between a customer and a trucker or fleet manager. The method includes a step of providing a means to input information into a database about an order of goods to be shipped, wherein the information in the database includes requirements for the shipment; a step of providing a means to input information into the database about one or more trucks and one or more routes the trucks are scheduled to take or are taking; a step of using an algorithm to determine if the requirements for the shipment are met by the one or more trucks; and a step of displaying a listing of the trucks that meet the requirements.

### CROSS-REFERENCE TO RELATED APPLICATIONS

This application claims priority from pending provisional patent application No. 62/233,229, filed on Sep. 25, 2015 and titled SYSTEM AND METHOD FOR PROVIDING A DYNAMIC LOADBOARD, the contents of which are incorporated herein by reference in their entirety.

### TECHNICAL FIELD OF THE INVENTION

The field of the invention generally relates to a software system for providing dynamic and real time information for truckers, shippers and brokers to maximize the load and efficiency of transportation of materials on trucks.

### BACKGROUND OF THE INVENTION

On a most basic level, truckers transport goods and materials from a source location where they pick up the goods/materials to a destination location where they deliver the goods/materials. Upon delivering the materials they return to their originating location, typically in the vicinity of the source location. As should be evident, this arrangement is inefficient if the truck returns empty to the originating location. To avoid this inefficiency, truckers will seek to ensure that they have a load for their return journey. Optimally, truckers will seek to ensure that the load for the return journey is immediately available at or near the destination location such that upon delivering the first shipment of goods/materials, the trucker can immediately load the truck with a second shipment of goods/materials. However, inefficiencies remain if the second shipment is not available immediately or is at a distant location from the destination location of the first shipment. Other inefficiencies exist if the first or second shipments do not completely fill the truck.

Shippers and brokers also encounter problems in moving goods/materials from the source location to the destination location. They must reach out to various trucking companies to find a truck that will be going between the two locations at a time suitable for the shipper and the recipient. Shippers and brokers must contact many truckers and trucking companies to seek the most suitable trucker or trucking company. This process involves sending emails and making telephone calls to a listing of truckers or trucking companies (e.g., to the trucking company's fleet manager or other suitable person). As can be imagined, this process is laborious, time-consuming and unlikely to be successful in most instances. This adds to the inefficiencies of moving goods/materials between locations which wastes fuel, increases costs and requires significant upfront planning.

To address the inefficiencies of a less than full payload, truckers will wait at truck stops or other locations to wait for a broker to contact them with a request to transport materials. This results in the truck waiting for an indeterminate time for a next load. Fortunately, with the advent of smart phones, truckers, shippers and brokers can keep in contact by emailing, texting or telephoning to make arrangements. Nonetheless, in spite of the ability to communicate with anyone at almost any time by telephone, text or email, this communication arrangement is not optimal for the truckers, trucking companies, shippers, and brokers.

### SUMMARY OF THE INVENTION

In one general aspect, the invention relates to a method for matching orders between a customer and a trucker or fleet manager. The method includes steps of:

providing a means to input information into a database about an order of goods to be shipped, wherein the information in the database includes requirements for the shipment;

providing a means to input information into the database about one or more trucks and one or more routes the trucks are scheduled to take or are taking;

using an algorithm to determine if the requirements for the shipment are met by the one or more trucks; and

displaying a listing of the trucks that meet the requirements.

Embodiments of the method may include one or more of the following features. For example, the requirements of the order of goods may include one or more of an Order ID, a Truck ID, a Customer ID, start route location name, start route location GPS coordinates, end route location name, end route location GPS coordinates, amount to be paid for the shipment, delivery date, characteristics of the order of goods, and status of the order.

The information in the database about the Trucks may include one or more of a truck ID, a trucker ID, a current GPS location, the type of truck, ability of the truck to transport hazardous materials, the registered origin location, certificates, insurance levels and current capacity of the truck.

The method may further include providing a means for the customer to communicate with one or more trucks displayed in the listing. The method may further include providing a means for the customer to offer the order a trucker. The method may further include providing a means for the trucker to confirm the order offered by the customer.

In another general aspect, the invention relates to a system for managing the logistics of a payload that comprises:

activating a customer user interface having content associated with offering an order for a payload;

activating a trucker user interface having content associated with a route to be traveled by the trucker and one or more offers for orders for a payload;

activating the customer user interface in response to a search of trucks that meets a set of requirements for the offer for the payload, wherein activating the customer user interface includes a listing of the trucks that meets the set of requirements;

sending a notification to a first trucker from the customer user interface in response to selecting the first trucker from the listing of the trucks that meets the set of requirements of the order when the first trucker is offered the order for the payload; and

sending a notification from the trucker user interface to the customer user interface in response to the first trucker accepting the order for the payload.

Embodiments may include one or more of the features described above or disclosed herein.

In another general aspect, the invention relates to a processor-readable medium storing code representing instructions to cause a processor to implement a method of managing the logistics of a payload, comprising instructions to:

activate a customer user interface having content associated with offering an order for a payload; activate a trucker user interface having content associated with a route to be traveled by the trucker and one or more offers for orders for a payload;

activate the customer user interface in response to a search of trucks that meets a set of requirements for the offer for the payload, wherein activating the customer user interface includes a listing of the trucks that meets the set of requirements;

send a notification to a first trucker from the customer user interface in response to selecting the first trucker from the listing of the trucks that meets the set of requirements of the order when the first trucker is offered the order for the payload; and

send a notification from the trucker user interface to the customer user interface in response to the first trucker accepting the order for the payload.

Embodiments may include one or more of the features described above or disclosed herein.

### DESCRIPTION OF THE DRAWINGS

FIG. 1 depicts a system diagram illustrating an arrangement of components in a dynamic loadboard system.

FIG. 2 depicts a system diagram illustrating a second arrangement of components in a dynamic loadboard system.

FIG. 3 illustrates a database arrangement and its contents for the dynamic loadboard system of FIGS. 1 and 2.

FIG. 4 is a website display for a Customer display of the dynamic loadboard system of FIGS. 1 and 2.

FIG. 5A is a website or smart phone display for a main screen of a Trucker or Fleet Manager display of the dynamic loadboard system of FIGS. 1 and 2.

FIG. 5B is a website or smart phone display for a Route Planning screen of a Trucker or Fleet Manager display of the dynamic loadboard system of FIGS. 1 and 2.

FIG. 5C is a website or smart phone display for a New Order screen of a Trucker or Fleet Manager display of the dynamic loadboard system of FIGS. 1 and 2.

FIG. 5D is a website or smart phone display for a Customers screen of a Trucker or Fleet Manager display of the dynamic loadboard system of FIGS. 1 and 2.

### DETAILED DESCRIPTION

The inventor has developed a system that permits truckers, trucking companies (e.g., fleet managers), shippers and brokers to communicate in a dynamic, real time manner to match payloads with trucks for both shipping and receiving destinations. The system permits the shipper or broker (customer) to input a payload and its characteristics (e.g., linear feet, weight, volume, number of pallets) as well as equipment needed for the shipment (e.g., refrigeration, forklift to load/unload), shipment location, pickup timing and destination. The system permits the trucker or trucking company to enter general information about the truck, such as payload capacity and refrigeration abilities. The system also permits the trucker or trucking company to respond to the input provided by the shipper or broker about a particular payload and secure an agreement to transport the goods/materials. As a consequence of the above system, efficiencies of the system are improved for each of the shipper, the broker, the trucker and the trucking company.

The system can be implemented in the form of a method of managing the logistics of a payload that comprises: activating a customer user interface having a first content associated with offering an order for a payload; activating a trucker user interface having a second content associated with a route to be traveled by the trucker and one or more offers for orders for a payload; activating the customer user interface in response to a search of trucks that meets a set of requirements for the offer for the payload, wherein activating the customer user interface includes a listing of the trucks that meets the set of requirements; sending a notification to a first trucker from the customer user interface in response to selecting the first trucker from the listing of the trucks that meets the set of requirements of the order when the first trucker is offered the order for the payload; and sending a notification from the trucker user interface to the customer user interface in response to the first trucker accepting the order for the payload.

The system also can be implanted as a processor-readable medium storing code representing instructions to cause a processor to implement a method of managing the logistics of a payload. The processor-readable medium storing code comprises instructions to: activate a customer user interface having a first content associated with offering an order for a payload; activate a trucker user interface having a second content associated with a route to be traveled by the trucker and one or more offers for orders for a payload; activate the customer user interface in response to a search of trucks that meets a set of requirements for the offer for the payload, wherein activating the customer user interface includes a listing of the trucks that meets the set of requirements; send a notification to a first trucker from the customer user interface in response to selecting the first trucker from the listing of the trucks that meets the set of requirements of the order when the first trucker is offered the order for the payload; and send a notification from the trucker user interface to the customer user interface in response to the first trucker accepting the order for the payload.

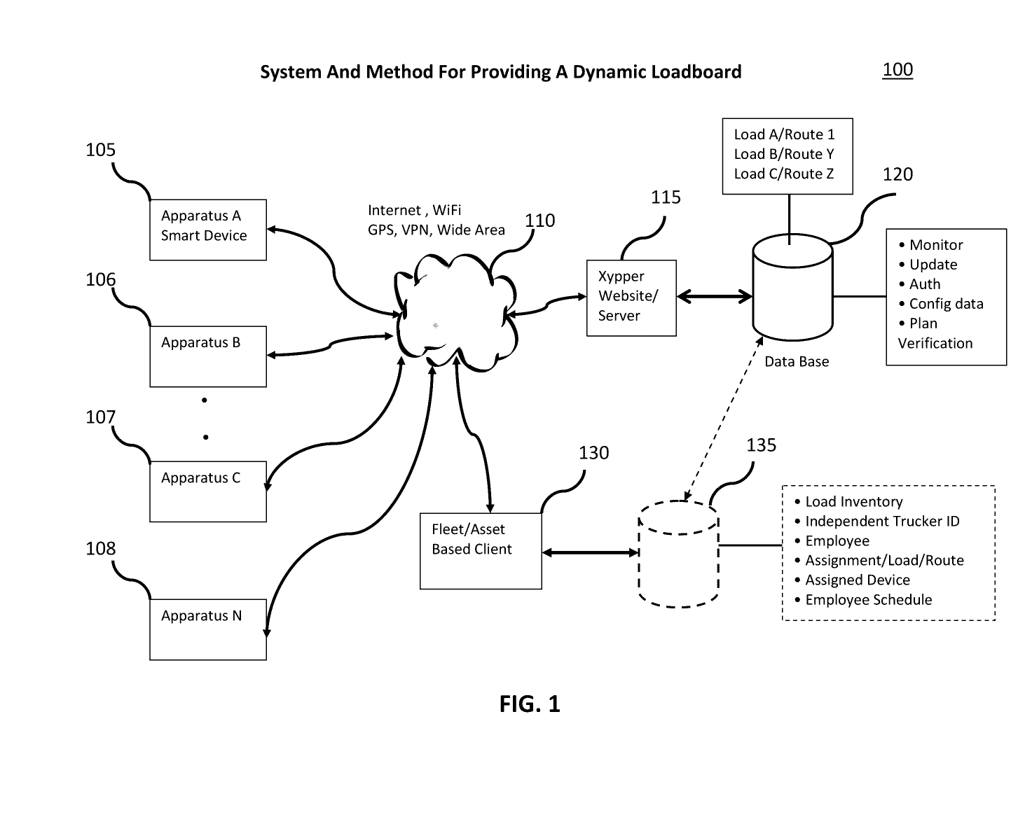

Referring to FIG. 1, a system 100 for providing a dynamic loadboard includes one or more apparatuses 105, 106, 107, 108, etc., such as smart phones. The apparatuses may be any conventional smart phone, smart device, laptop, notebook or other computer. The apparatus needs the ability to communicate over the Internet or similar communication means 110 (e.g., WAN, VPN, GPS, WiFi) either wirelessly or through a wired or fiber optic connection. In general, the apparatuses are not to be limited to current and conventional smart phones and the like.

The apparatuses are digitally connected to other devices in the system 100, including a website or server 115 and a data base 120. The digital connect between the apparatuses and the other devices may be made over the internet, by a WAN, VPN, GPS, WiFi or over the Internet. The particular type of digital connection is not as important as the ability to achieve a connection between the apparatuses, the website or server, and the database to ensure continuous connectivity with real time and dynamic access to information input by shippers, brokers, truckers and trucking companies. As used herein, shippers and brokers are interchangeably referenced as customers.

The website or server 115 will provide an interface between the apparatuses 105-108 and the database 120. The database 120 includes dynamic and static data. For example, the dynamic data can include payload related information, such as the proposed loads and routes. The shipper or broker uses their apparatus (e.g., Apparatus A 105) to input information about the load, such as number of pallets, linear feet of the load, weight, volume, shipping requirements (e.g., refrigeration, loading/unloading requirements), shipment pickup location and date, and shipment delivery location and date. The trucker or trucking company uses the apparatus (e.g., Apparatus B 106) to input information about a route that a truck is going to take, the timing for taking the route, the amount of space left in the truck for cargo, and any other relevant information for the trip. For example, the space in the truck may be measured by the number of pallets and the trucker or trucking company may input information about any scheduled payloads with reference to the number of pallets scheduled in the truck. Similarly, the space in the truck may be measured by the linear feet available and the trucker or trucking company may input information about any scheduled payloads with reference to the linear feet scheduled in the truck and available linear feet remaining available in the truck.

The trucker or trucking company can be in the form of a fleet of trucks or a single independent truck 130. Information about the fleet or single truck can be stored in a database 135 that is the same as or in communication with the database 120. For example, if the trucker is a single independent truck the database 135 may include the independent trucker's ID as well as dynamic information such as current assignment, current load, current route, assigned device, and load inventory (e.g., number of pallets carried or linear feet used). If the database 135 is for a fleet of trucks, the database can include information such as employee information and schedule as well as truck ID for each truck. The database information also can include dynamic information such as load inventory, current assignment, load and route, and assigned device.

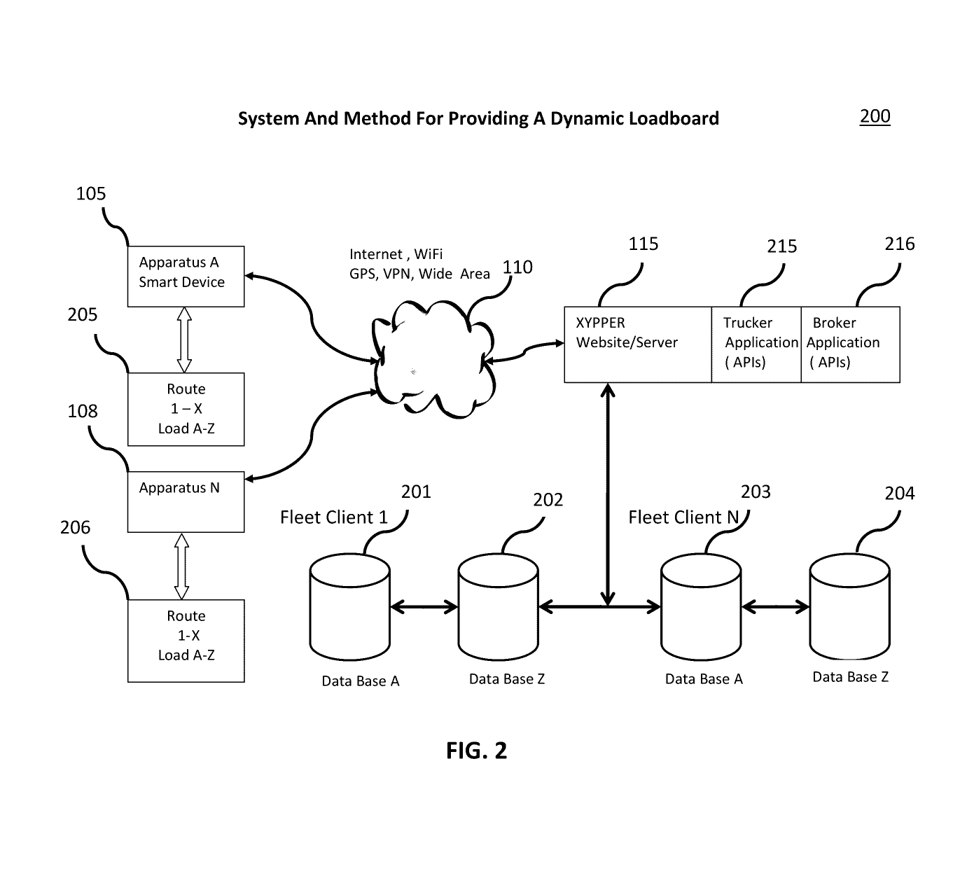

Referring to FIG. 2, another embodiment of a system for providing a dynamic loadboard is in the form of a system 200 that includes one or more apparatuses 105, 108, etc., such as smart phones, that are used to store route information 205, 206, etc. The apparatuses may be any conventional smart phone, smart device, laptop, notebook or other computer. The apparatus needs the ability to communicate over the Internet or similar communication means 110 (e.g., WAN, VPN, GPS, WiFi) either wirelessly or through a wired or fiber optic connection. In general, the apparatuses are not to be limited to current and conventional smart phones and the like.

The apparatuses are digitally connected to other devices in the system 200, including a website or server 115. The digital connect between the apparatuses and the other devices may be made over the Internet, by a WAN, VPN, GPS, or WiFi. The particular type of digital connection is not as important as the ability to achieve a connection between the apparatuses and the website or server and the database to ensure continuous connectivity with real time and dynamic access to information inputted by shippers, brokers, truckers and trucking companies. The website/server 115 communicates with a trucker application programming interface (API) 215 and a broker, shipper or customer API. The website/server 115 also communicates with a series of fleet client databases 201, 202, 203, 204, etc. that contains information about truck characteristics, routes, timing, etc.

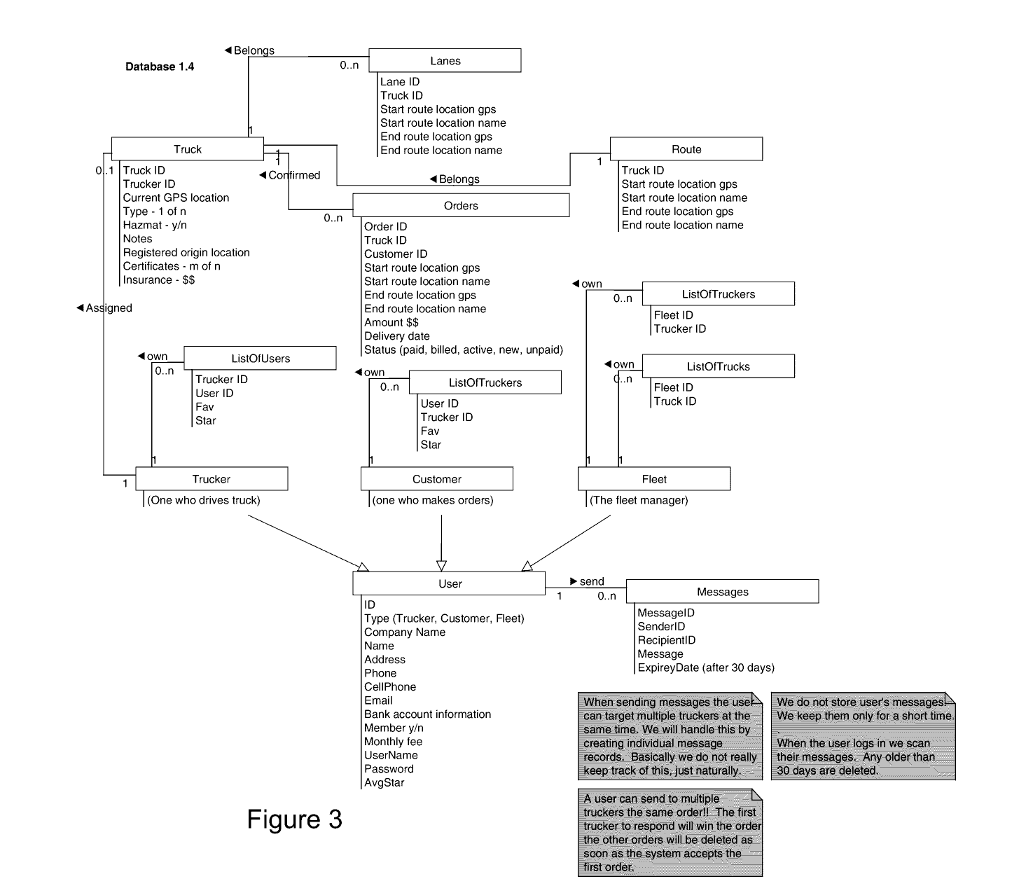

Referring to FIG. 3, the database 120 includes a data set “truck” for individual trucks, including a truck ID, a trucker ID, a current GPS location, the type of truck, whether the truck can transport hazardous materials (hazmat), notes about the truck, the registered origin location (e.g., Canada, US, Mexico, etc.), certificates, and insurance levels. For example, the system may include a unique identifier assigned for each truck enrolled in the system. Similarly, each truck driver may include a unique identifier assigned for each driver enrolled in the system. The unique identifiers for each truck and driver is particularly useful when an independent trucker with a single truck is enrolled in the system. The current GPS location information is dynamic and permits the system to respond in a real time mode to an inquiry by a customer (e.g., shipper or broker) seeking to transport goods. By knowing the location of a truck the system permits an improved ability to match a truck/trucker with a customer/shipper desiring to move goods. The type of truck information in the database is useful for determining whether a truck can be used for a particular load, such as number of pallets or linear feet of a load that can be carried as well as requirements of refrigeration, loading/unloading equipment, liquid capabilities, etc. The type of truck also can include information that relates to the dimensions of the truck. For example, Type 11 may be a 28′ High Cube Trailer, Type 12 may be a 45′ Wedge Trailer, Type 13 may be a 48′ Wedge Trailer, Type 14 may be a 53′ Wedge Trailer and Type 15 may be a 53′ Trailer. Each of these types of trailers will have industry standard dimension of length, inside width, inside height (rear, center, front), door opening width, door opening height, rear floor height, cubic capacity, overall width, and overall height. Similarly, the ability to transport hazardous materials may be critical for transporting hazardous materials so a truck's ability to transport such types of loads is critical. As such, the type of truck will be used to more clearly specify the truck.

The registered origin location is needed when a shipment may be limited to transporters of a particular country or state. For example, some materials may be required by law or regulation to be transported only by a U.S. registered carrier. In such cases, the customer/shipper will need to ensure that the truck used is registered in the U.S. Some shippers may be required by contract to ensure that the shipment is ensured by a trucker to a particular level of insurance and have particular types of certificates. Therefore having the ability to search for a trucker that meets these requirements will clearly reduce the time needed to find a suitable truck and improve the ability of shippers to move goods on short notice.

The data set “Lanes” refers to the route that a particular truck will travel or typically travels. The data set “lanes” will be based on individual trucks and therefore will include the Truck ID data. A search for an available truck can be limited to trucks that travel within a set distance of a route. For example, the data for Lane ID may refer to a particular Interstate route, e.g., I-10. During a search for a truck, a customer/shipper in proximity of I-10 will be returned trucks that have a route within 10, 20, . . . 50 miles of that shipper's location. If a truck's lane ID refers to Interstate 10, this truck would be listed amongst possible trucks for that shipper. The Lane ID data may be dynamic, for example if the truck goes no different routes, or static, for example, if the truck has a set route that does not vary. The data set “lanes” also will include starting and ending route locations for each truck in that data set. Examples of the data that may be in the data set for each truck will be the start route location name and GPS coordinates and the end route location name and GPS coordinates.

The data set “Routes” is data for each truck and includes a truck identifier (Truck ID) and that truck's start route location name and GPS coordinates and the end route location name and GPS coordinates for a particular route that truck takes regularly (static) or irregularly (dynamic).

The data set “Orders” refers to multiple shipping order that customers/shippers have placed or intend to place, e.g., ship ten pallets (e.g., 40 linear feet) of goods from a warehouse at one location to a store at a different location. Each order will be associated with an Order ID, a Truck ID, a Customer ID, start route location name and GPS coordinates and end route location name and GPS coordinates, Amount ($) agreed to be paid for the shipment, Delivery date and Status of the order (amount paid, billed, active, new, unpaid). The Order ID is a unique number or value associated with a particular order and is generated when the order is created. The Customer ID is a unique number or value associated with a particular shipper/broker who is enrolled in the system. The Customer ID may be an identifier for a company, a division of a company, or a plant, store or warehouse. The Amount ($) is a proposed or agreed upon payment from the customer to the trucker to pay for transporting the goods from the start location to the end location. The Delivery date is the desired or agreed upon delivery date of the goods that the customer is proposing to ship or has agreed to ship. The Status is a dynamic value that changes based on the progression of the shipment. Initially the Status will be new, and then when the order is agreed upon the status would become active. The status also will include the payment status, which ranges from billed to unpaid to paid.

The data set “List of Users” is the data relating to trucks. The data set includes each Truck ID along with the User ID associated with each Truck ID. The data set also includes information such as Fav and Star to reference ratings that each Truck ID has from the customers. The Fav and Star ratings will be provided by customers (see “Customer” data set) who may have developed a preference for particular truck drivers, trucks or fleets of truck and will attempt to use those drivers, trucks or fleets whenever possible. For example, a customer attempting to place an order may specify that the order should be filled by a particular Truck ID or Fleet ID (a company with a fleet of truck as opposed to a single truck).

The data set “List of Truckers” is the data relating to individual truck and includes the Truck ID, User ID, and information such as Fav and Star to reference ratings that each Truck ID has from the customers.

For a fleet of trucks there is a data set “Fleet” that draws data from data sets “List of Trucks” and “List of Truckers” which contain values such as Fleet ID (to identify the fleet), Trucker ID and Truck ID. The fleet manager ensures that the data relating to the trucks and truck drivers is kept current and accurate.

The data set “User” encompasses independent truckers, fleets of trucks and customers (i.e., shippers and brokers). Each user of the system will have data associated with that user. The data includes an identifier (ID); the type of user, such as Trucker, Customer, Fleet (Type); and contact information such as Company Name, Name, Address, Phone Number, Cell Phone Number, and Email address; bank account information, member status (yes or no), a user name and password to access the system, and a rating or ranking based on the experience of other users with any particular user (AvgStar).

The data set “Messages” permits real time communication abilities between users of the system. For example, a customer may contact a trucker to check on the status of a particular order. The data set “Messages” includes the MessageID to uniquely identify each message, a SenderID, a RecipientID, a message and an expiry date for the message (generally set to expire 30 days after sending). While a message may be sent between a particular customer and trucker, the message may be message between a customer and many truckers at the same time. For example, a message may be sent by a customer seeking to target multiple truckers at one time for a particular order. Once a trucker responds and “wins” the order, the message will be deleted to prevent many truckers continuing to respond to the message.

In use of the systems 100 and 200, a user, whether a trucker, fleet manager or customer, uses a computer or smart phone to initially enroll. In a first screen the user is presented with an option to enroll or login. If enrolling, a trucker or fleet manager will enter profile information, truck information for each truck, and bank account information. The user then will download an app to facilitate interactions between the customers, truckers and fleets. For a fleet, the fleet manage may choose to input information for all the trucks and truckers initially or later when convenient. Ultimately, the trucker, fleet manager and customers will enter all the information described above in the database 120.

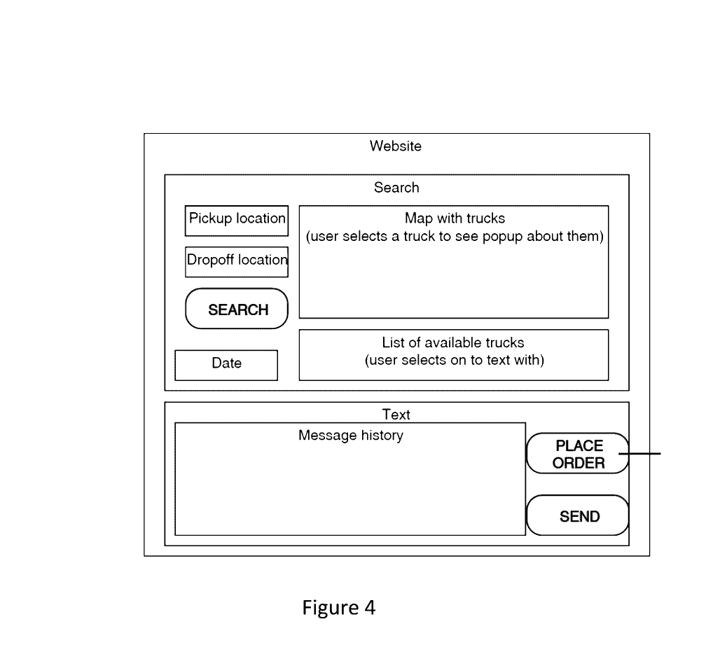

Once a user is enrolled in the system, a customer may decide to ship an order of goods, for example a pallet of items from warehouse A to store B, both of which are in different states. The customer uses the app downloaded to a computer or smart phone to login. Referring to FIG. 4, in one embodiment, the customer will be presented with a screen for entering the desired pickup and drop off locations for the pallet of items to be shipped from warehouse A to store B, as well as the date for the shipment. Optionally, the system can include means to input characteristics of the load, e.g., linear feet of the goods, number of pallets (if pallets are being used for the shipment), approximate weight and dimensions, need to include refrigeration, types of certificates required, insurance requirements, and registered origin location requirements. Upon activating the hyperlink on the screen for searching, the results include a map displaying the location of trucks that meet the requirements of the customer. The user may hover over a truck or select a truck to see a popup window displaying information about the truck.

Another window or portion of the screen may include a list of available trucks. The customer can select one or more of these trucks to communicate with, e.g., through text messaging. The customer sends text messages to one or more trucks to offer the order. Through text messages between the customer and truckers or fleet managers, an agreement will be made between the customer and a trucker of fleet manager. At that time the customer selects the truck and activates a hyperlink to place the order.

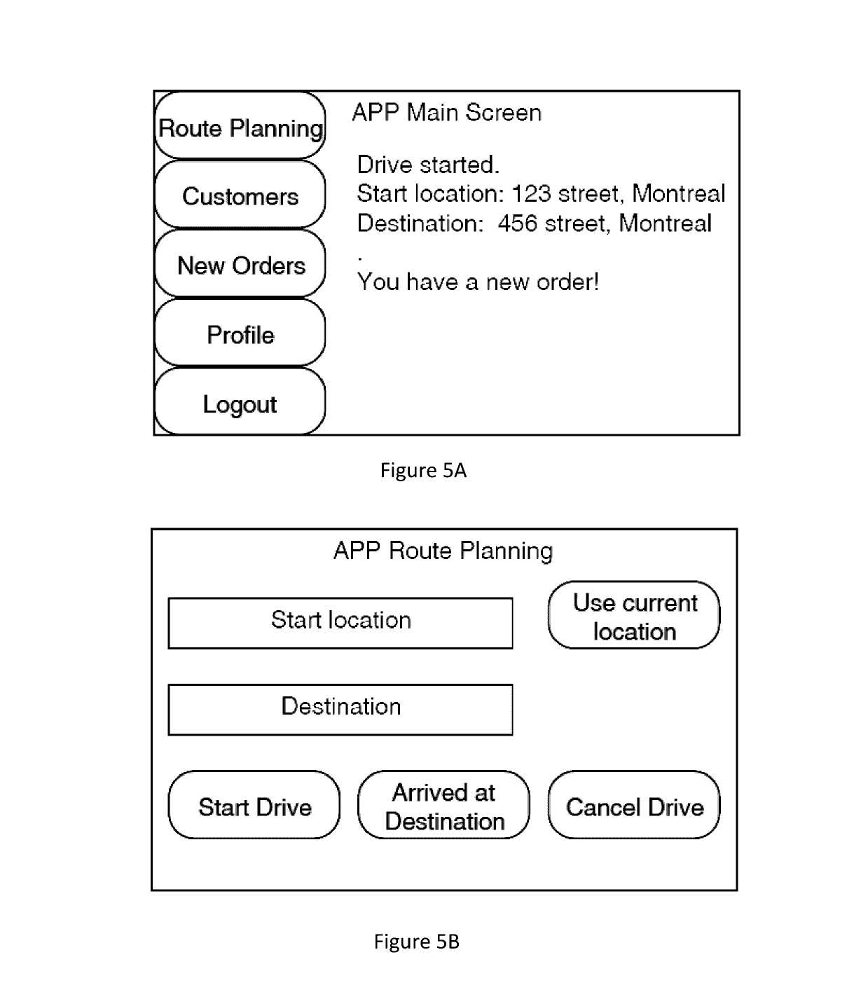

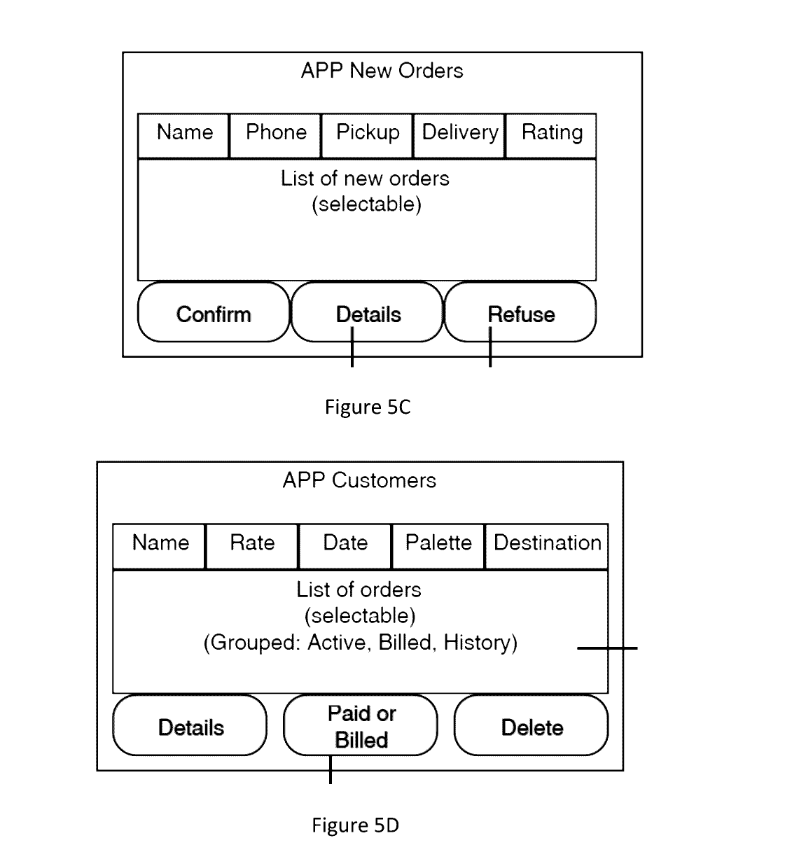

In parallel to the actions of the customer, the trucker uses a software application to be notified of potential orders, review potential orders, and accept or decline orders. Referring to FIG. 5A, a main screen of the software application for the trucker includes hyperlinks for Route Planning, Customers, New Orders, Profile and Logout. The main screen also will include the status of the drive, e.g., planned, started, and ended. The main screen also will include listings of start and destination locations, and notifications, such as a new order being placed with the trucker or that potential orders exists that the trucker is eligible to seek to “win.”.

Referring also to FIG. 5B, prior to starting a trip, the trucker will select the hyperlink for Route Planning and subsequently be presented with a screen to enter a starting location and destination location. The screen may also include one or more hyperlink buttons to select the current location as the start location, to indicate that the trucker has started the drive (e.g., providing a notification to the system that the trip has begun), to end the drive (e.g., to provide a notification to the system that the truck as arrived at is ultimate destination), or to cancel the drive. While driving, the application pings or otherwise communicates with the system to provide location information. In this manner, the system has accurate real time location information about each truck using the system during a trip. For example, the system can update the database 120 to provide continuously accurate truck location information.

Referring to FIG. 5C, when the customer sends messages to one or more truckers about a potential order for which they are eligible to bid upon, the trucker receives a notification on the main screen (FIG. 5A). From the main screen, the trucker selects the hyperlink to New Orders, which results in the display of the screen, New Orders (FIG. 5C). On the New Orders screen the display will include a listing of potential new orders. Information that is listed for each potential new order includes name of the customer, phone number of the customer, pickup date and location, delivery location, and rating of the customer. The trucker can select one of multiple potential orders and, using a hyperlink to Details, see additional details about the order, a map display of the pickup and delivery locations, and texts from the customer. Because the trucker will know the telephone number of the customer, the trucker can use a cell phone (e.g., a smart phone) to text with or call the customer to negotiate details about the order. Finally, from this screen the trucker can confirm or refuse an order. Once the customer has offered the order to the trucker and the trucker has confirmed the order, the order will be added to the database for both the website database and the truck app database. In addition to adding the order to the database, the system will cause a bill of lading to be generated and provided to the trucker to accompany the goods to be transported. The bill of lading may be stored in the database in association with one or more of the order, the customer and the trucker.

Referring to FIG. 5D, from the main screen (FIG. 5A) the trucker can select the hyperlink button to Customers and can scroll through the listing of customers that have placed orders with the trucker. The screen displays a listing of orders that include a display of order-related information such as name of the Customer, Rating of the Customer, Date of the Order, number of Pallets (and/or linear feet of the goods) and Destination of the Order. The orders also can be group as active (e.g., orders that the trucker is currently handling), billed (e.g., the order was delivered and billed but not yet paid), and history (e.g., a listing of all orders that are not either active or billed). Each order can be selected to view more information about the order, to enter information about the status of the order (e.g., active or billed), or delete an order.

When the trucker and truck pick up the order from the customer, the trucker will update the status of the order to be active and view the bill of lading to ensure that the goods being transported correspond to the bill of lading. The trucker and truck then will resume the journey. Upon arriving at the destination of the order from the customer, the trucker will add any accessorial charges and the recipient of the goods will electronically sign for delivery, which will generate an invoice to be sent to the customer. The accessorial charges, electronical acknowledgement of delivery, and invoice will all be stored in the database. Further, the status of the order will be changed from active to billed. Upon payment of the invoice by the customer, the status of the order will be changed from billed to history and that information stored in the database. Automatic generation of the order paperwork, including bill of lading, proof of delivery and invoice, provides advantages to both the customer and the trucker/fleet manager by saving the time required to generate all the paperwork.

In one embodiment, the systems above include a means to measure and track capacity of a truck to carry goods throughout the duration of the trip. For example, a standard 53′ enclosed trailer is fifty-two feet in length, ninety-nine inches in inside width, between 110 and 111 inches in inside height, and 4050 cubic feet in volume. The system may track truck capacity based on the linear feet of the goods or the number of pallets that will fit in the trailer. A standard 53′ trailer will fit two 48″ by 48″ pallets side-by-side to fill the width and thirteen pallets deep, resulting in twenty-six pallets single stacked or fifty-two pallets double stacked to fill the trailer. By tracking the number of pallets carried in a trailer at any particular time and location, the system can calculate the number of pallets that can be further included at any particular time. This calculation involves storing and tracking the number of pallets at any point during the route and updating that information as more orders are entered for that truck. The calculation therefore will know at any particular time how much space will be available during an upcoming trip and where on that trip the space will be available. Although the system can use the number of pallets, the system can instead or concurrently use linear feet of the goods to track and calculate the shipment of goods.

Referring to FIG. 6, the systems 100 and 200 above may be practiced as follows. First, a customer enrolls in the system, inputs the information described above about the customer, and downloads an app for a smart phone or goes to the website for the system. The information entered by the customer then is added to the database. Independent of the enrollment of the customer, a trucker or fleet manager enrolls in the system, input the information described above about the trucker/truck or fleet/trucks, and downloads an app for a smart phone and/or goes to the website for the system.

At a certain time, a trucker or fleet manager has scheduled a shipment from a first location to a second location for a first customer. In one instance, the trucker logs into the system, for example on a smart phone on which the app has been downloaded, and enters the start or pickup location for the shipment and enters the end or drop off location for the shipment. Optionally, the trucker may enter the start date if that date is in the future. The information entered by the trucker is added to the database. Therefore, the database will contain one or more of lane information for the trip, start and end route location (GPS and/or name), Truck ID, Trucker ID, Current Location, Type of Truck, Hazmat (yes or no), Notes, registered origin location, certificates associated with the truck, and Insurance coverage. If the truck is a part of a fleet, the database also will include the Fleet ID. It should be understood that for this particular shipment the trucker also will include the number of pallets that are carried within the trailer or the linear feet of the trailer filled with the goods within the trailer. Therefore, the database will know the capacity remaining within the trailer between the starting and ending locations.

Independent of the activities of the trucker or fleet manager, when a second customer has the need to transport some goods from one location to another (e.g., from a warehouse in one state to a store in another state), the customer logs into the system and enters information about the order: start route location (GPS and/or name), destination route location (GPS and/or name), amount to be paid, desired delivery date, certificate information requirements, insurance requirements, registered origin requirements, and/or number of pallets and/or linear feet of goods to be shipped. It should be understood that depending upon the goods being transported, the second customer may need only a subset of that information verified by a trucker while for another shipment the customer may need a different subset of information verified. The information entered by the second customer will be added to the database.

With the information entered, the second customer then activates the search hyperlink to provide a map of trucks that meet the requirements of the customer. The map of trucks will be populated based on (a) meeting the requirements set out by the second customer, (b) the start route location (e.g., the pickup location), (c) the end route location (e.g., the drop off location), (d) a calculation of the remaining capacity within the trailer between the start route location and the end route location specified by the customer, and (e) a calculation of the distance between the start route location and the lane (e.g., road) that the Truck is following on its route. For example, all trucks that meet the requirements set out by the second customer and have a lane that is within 10 miles, 20 miles, . . . 50 miles, etc. of the start route location of the customer will be displayed. Optionally, the second customer can vary the display requirements to encompass more trucks or fewer trucks that meet the requirements of the customer.

With the search run, the second customer will see a screen display showing a map with the trucks as well as a listing of available truck ordered, for example, ordered based on meeting the requirements of the customer, including the proximity of the lane to the start route location of the customer. The second customer then will select one or more trucks (truckers and/or fleet managers) to text with or otherwise engage in a communication dialog. Upon an agreement being reached between the second customer and trucker/fleet manager, the customer activates the Place Order hyperlink. This information is transmitted to the trucker/fleet manager who will receive a notification of a new order on the Truck App main screen, selects the New Orders hyperlink, and reviews the New Orders screen to see the order. The trucker/fleet manager then activates the Confirm hyperlink to complete and confirm the order. Information about the confirmed order is then added to the database. The system further generates a bill of lading to be associated with the order. In addition, the capacity of the truck is updated to reflect the capacity at each point along the route and this information is added to the database. When the trucker arrives at the second customer's location, and the truck is loaded with the goods, the trucker automatically accepts and receives the bill of lading for the goods.

As the truck progresses along the route a third customer with an order of pallets to be shipped between two locations follows the same actions as the second customer, including the number of pallets or linear feet of goods being shipped. As with the second customer, a screen is displayed with a map and listing of available trucks. The trucks displayed will again be displayed and listed based on meeting the requirements of the third customer, including distance between the lane and start location of the third customer, and available capacity of the truck between the start and end locations of the shipment of the third customer. A truck that does not have the capacity between the start and end locations of the shipment of the third customer will not be displayed to the third customer. However, when a delivery from the truck is made (e.g., the shipment of the second customer is delivered), the database is updated and the truck capacity recalculated. When the trucker has delivered the order, the trucker goes to the trucker app main screen and then the customer screen to select and update the order to show that it was delivered (i.e., from active to billed). As part of the delivery process, the recipient of the goods electronically signs for the goods and generates a proof of delivery document which is both stored in the database and provided to one or more of the customer, trucker, fleet manager and recipient of the goods. The truck driver then enters any additional information to create the invoice, e.g., any accessorial charges generated by or for the shipment, and the invoice is automatically generated by the system, delivered to the customer and stored in the database. If the customer pays the bill, then the trucker changes the status from billed to history, or alternatively, acknowledgement of the invoice payment by the trucker automatically changes the status from billed to history. The status of the order (e.g., active, billed, history) will be updated in the database.

Next, a fourth customer with a potential order having requirements that are met by the truck, will find that truck displayed on the customer screen. The truck will be displayed based on distance between the lane (route) and the start location of the shipment of the fourth customer as well as the capacity of the truck being the same as or more than that in the order. The fourth customer and trucker go through the same procedure as described above and accept and confirm the order.

Upon delivering all orders, including the initial shipment, the trucker goes to the Trucker App and activates the “Arrived at Destination” hyperlink to show that the trip has been completed and the last shipment delivered. Of course, to the extent the trucker desires, the trucker may constantly receive and confirm orders for the return trip to the original starting location. In this manner, the trucker can maximize and optimize the efficiency of the transport system. In current practice, too often a truck will return to its original destination empty, which is a waste of fuel for the return trip. Therefore there is an environmental benefit, as well as a financial advantage, if the capacity of the truck is filled during most, if not all, of a complete trip. Specifically, the trucker can ensure that the truck is filled as much as possible for every mile or kilometer that the truck travels. This improved efficiency can be used to reduce shipping costs and reduce the lead time needed between placing an order for shipping and having that order picked up and shipped. Further, the customer needs to spend significantly less time inefficiently seeking out a suitable shipper (i.e., truck or fleet) because instead of going through (i.e., calling or emailing) a list of trucks and fleets to find a truck going along the route needed, meeting the requirements described above, and having the required capacity, the customer merely enters information about the order, conducts a search and starts a quick communication dialog with the one or more truckers.

Another advantage provided by the system is the ability to automatically generate the documents needed for a transaction involving transport of goods. For example, the bill of lading is automatically generated upon confirmation of the order by the trucker, the proof of delivery of delivery is generated upon acceptance of the goods at the destination, and an invoice is sent from the trucker to the customer upon generation of the proof of delivery.

The above systems may be implemented in

[symbol]

While several particular forms of the systems have been illustrated and described herein, it will be apparent that various modifications and combinations of the inventions detailed in the text and drawings can be made without departing from the spirit and scope of the inventions. Accordingly, it is not intended that the inventions be limited, except as by the appended claims and other embodiments are within the scope of the following claims.

1. A method for matching orders between a customer and a trucker or fleet manager, the method comprising:
providing a means to input information into a database about an order of goods to be shipped, wherein the information in the database includes requirements for the shipment;
providing a means to input information into the database about one or more trucks and one or more routes the trucks are scheduled to take or are taking;
using an algorithm to determine if the requirements for the shipment are met by the one or more trucks; and
displaying a listing of the trucks that meet the requirements.

2. The method of claim 1, wherein the requirements of the order of goods includes one or more of an Order ID, a Truck ID, a Customer ID, start route location name, start route location GPS coordinates, end route location name, end route location GPS coordinates, amount to be paid for the shipment, delivery date, characteristics of the order of goods, and status of the order.

3. The method of claim 1, wherein the information in the database about the Trucks includes one or more of a truck ID, a trucker ID, a current GPS location, the type of truck, ability of the truck to transport hazardous materials, the registered origin location, certificates, insurance levels and current capacity of the truck.

4. The method of claim 1, further comprising providing a means for the customer to communicate with one or more trucks displayed in the listing.

5. The method of claim 1, further comprising providing a means for the customer to offer the order a trucker.

6. The method of claim 1, further comprising providing a means for the trucker to confirm the order offered by the customer.

7. A system for managing the logistics of a payload that comprises:
activating a customer user interface having content associated with offering an order for a payload;
activating a trucker user interface having content associated with a route to be traveled by the trucker and one or more offers for orders for a payload;
activating the customer user interface in response to a search of trucks that meets a set of requirements for the offer for the payload, wherein activating the customer user interface includes a listing of the trucks that meets the set of requirements;
sending a notification to a first trucker from the customer user interface in response to selecting the first trucker from the listing of the trucks that meets the set of requirements of the order when the first trucker is offered the order for the payload; and
sending a notification from the trucker user interface to the customer user interface in response to the first trucker accepting the order for the payload.

8. A processor-readable medium storing code representing instructions to cause a processor implement a method of managing the logistics of a payload comprises instructions to:
activate a customer user interface having content associated with offering an order for a payload; activate a trucker user interface having content associated with a route to be traveled by the trucker and one or more offers for orders for a payload;
activate the customer user interface in response to a search of trucks that meets a set of requirements for the offer for the payload, wherein activating the customer user interface includes a listing of the trucks that meets the set of requirements;
send a notification to a first trucker from the customer user interface in response to selecting the first trucker from the listing of the trucks that meets the set of requirements of the order when the first trucker is offered the order for the payload; and
send a notification from the trucker user interface to the customer user interface in response to the first trucker accepting the order for the payload.
